(19) United States
(12) Patent Application Publication
(10) Pub. No.: US 2020/0018977 A1
(43) Pub. Date: Jan. 16, 2020

(54) DISPLAY DEVICE AND AUTOMOBILE HEAD-UP DISPLAY SYSTEM USING THE SAME

(71) Applicant: CONSERVE & ASSOCIATES , Inc., Taoyuan City (TW)

(72) Inventors: ZONG QIN, Taoyuan City (TW); SHIH-MING LIN, Taoyuan City (TW); KUANG-TSO LUO, Taoyuan City (TW)

(21) Appl. No.: 16/034,806

(22) Filed: Jul. 13, 2018

(51) Int. Cl. G02B 27/01; G02B 5/10

(52) U.S. Cl. CPC G02B 27/0179; G02B 27/0101; G02B 2027/0141; G02B 2027/0185; G02B 5/10

(57) ABSTRACT

An automobile head-up display system includes a windshield and a display device, wherein the display device comprises a single picture generation unit and an optical imaging module. The picture generation unit is set inside an automobile body to generate a first imaging light and a second imaging light. The optical imaging module is arranged at the light-output side of the picture generation unit to reflect the first imaging light onto a surface of a windshield via a first optical path and reflect the second imaging light onto the surface of the windshield via a second optical path. In this manner, a first virtual image and a second virtual image are generated, wherein the distance of the first optical path is smaller than the distance of the second optical path.

### BACKGROUND OF THE INVENTION

### 1. Field of the Invention

The present invention relates to a display device and an automobile head-up display system using the same, particularly to a display device using a single picture generation unit (PGU) to generate a plurality of virtual images with different virtual image distances and an automobile head-up display system using the same.

### 2. Description of the Prior Art

During driving, the action that the driver lowers his head to watch the instrument panel or other consumer electronic devices may interfere with the action of observing the traffic status and cause accidents. Therefore, transferring the driving information from the instrument panel to a head-up display (HUD) becomes an important approach to driving safety improvement.

With the evolution of HUDs, more and more functions are attached to HUDs, e.g., the augmented reality HUD (AR-HUD). Only a single virtual image with a single virtual image distance is insufficient for those new types of HUDs. In other words, those new types of HUDs normally need a plurality of virtual images with different virtual image distances. Thereby, the information of navigation, maps, etc. may be presented on far virtual images, and the information of speed, oil quantity, etc. may be presented on near virtual images. FIG. 1 schematically shows an HUD with a plurality of virtual images. The HUD in FIG. 1 has a virtual image VI-1 whose virtual image distance to the driver is VI-P1 and a virtual image VI-2 whose virtual image distance to the driver is VI-P2. The conventional technologies usually use the following two methods to realize the HUD with a plurality of virtual images.

One of the methods uses two picture generation units (PGUs) and two optical projection systems; for example, one set of the PGU and the optical projection system is installed under the instrument panel; the other set of the PGU and the optical projection system is installed on the ceiling of the cockpit. The two sets of systems respectively generate two virtual images with two different virtual image distances. Another one of the methods uses two PGUs and a single optical projection system, as shown in FIG. 1, wherein PGUs 2 and 3 and an optical projection system 4 are installed under the instrument panel. The two PGUs 2 and 3 generate virtual images with different virtual image distances using different object distances O1 and O2 with respect to the optical projection system 4. The conventional technologies must use a plurality of PGUs to generate a plurality of virtual images with different virtual image distances, which not only raises the cost but also increases the difficulties of installation, system driving, and modulation.

Accordingly, the Inventors proposes the present invention to overcome the abovementioned problems of the conventional technologies.

### SUMMARY OF THE INVENTION

The present invention provides an automobile head-up display system, which uses a single picture generation unit (PGU) to generate at least two virtual images with different virtual image distances for supplying the driver with a plurality of pieces of driving information and decreasing the costs of components and assemblage.

In one embodiment, the automobile head-up display system of the present invention comprises a windshield and a display device. The windshield is joined with an automobile body of an automobile and has a surface able to reflect light. The display device includes a PGU and an optical imaging module. The PGU is disposed inside the automobile body and generates a first imaging light and a second imaging light. The optical imaging module is disposed at a light-output side of the PGU and includes at least one plane mirror and at least one first curved mirror, which reflect the first imaging light to the surface of the windshield through a first optical path and reflect the second imaging light to the surface of the windshield through a second optical path to respectively form a first virtual image and a second virtual image. The distance of the first optical path is smaller than the distance of the second optical path.

In one embodiment, the display device of the present invention includes a PGU and an optical imaging module. The PGU is disposed inside an automobile body of an automobile and generates a first imaging light and a second imaging light. The optical imaging module is disposed at a light-output side of the PGU and includes at least one plane mirror and at least one first curved mirror, which reflect the first imaging light to the surface of the windshield through a first optical path and reflect the second imaging light to the surface of the windshield through a second optical path to respectively form a first virtual image and a second virtual image. The distance of the first optical path is smaller than the distance of the second optical path.

Below, embodiments are described in detail in cooperation with the attached drawings to make easily understood the objectives, technical contents, characteristics and accomplishments of the present invention.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is a diagram schematically showing a conventional automobile head-up display system;

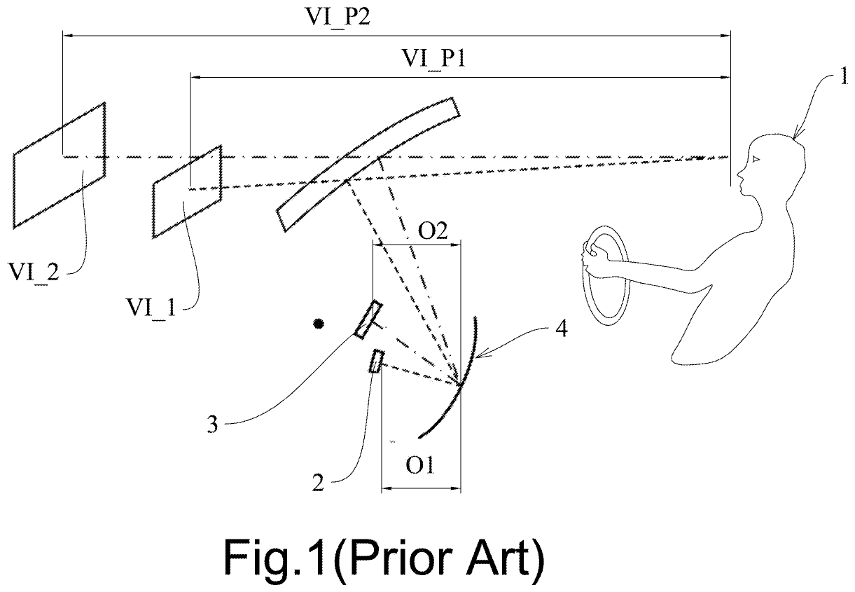

FIG. 2 is a diagram schematically showing a display device and an automobile head-up display system using the same according to one embodiment of the present invention;

FIG. 3 is a diagram schematically showing a picture generation unit (PGU) according to one embodiment of the present invention;

FIG. 4 is a diagram schematically showing a display device and an automobile head-up display system using the same according to another embodiment of the present invention;

FIG. 5 is a diagram schematically showing a display device and an automobile head-up display system using the same according to yet another embodiment of the present invention;

FIG. 6 is a diagram schematically showing a display device and an automobile head-up display system using the same according to still another embodiment of the present invention;

FIG. 7 is a diagram schematically showing the field of view (FOV) according to one embodiment of the present invention;

FIG. 8a and FIG. 8b are diagrams respectively schematically showing the optical paths of two display regions of a display device and an automobile head-up display system using the same according to one embodiment of the present invention;

FIG. 9a and FIG. 9b are diagrams respectively showing the imaging simulations of the grid patterns of the first display region and the second display region according to one embodiment of the present invention;

FIG. 10a and FIG. 10b are diagrams respectively showing the modulation transfer function (MTF) at the cut-off frequency of different fields of the first display region and the modulation transfer function (MTF) at the cut-off frequency of the fields of the second display region according to one embodiment of the present invention.

### DESCRIPTION OF THE PREFERRED EMBODIMENT

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

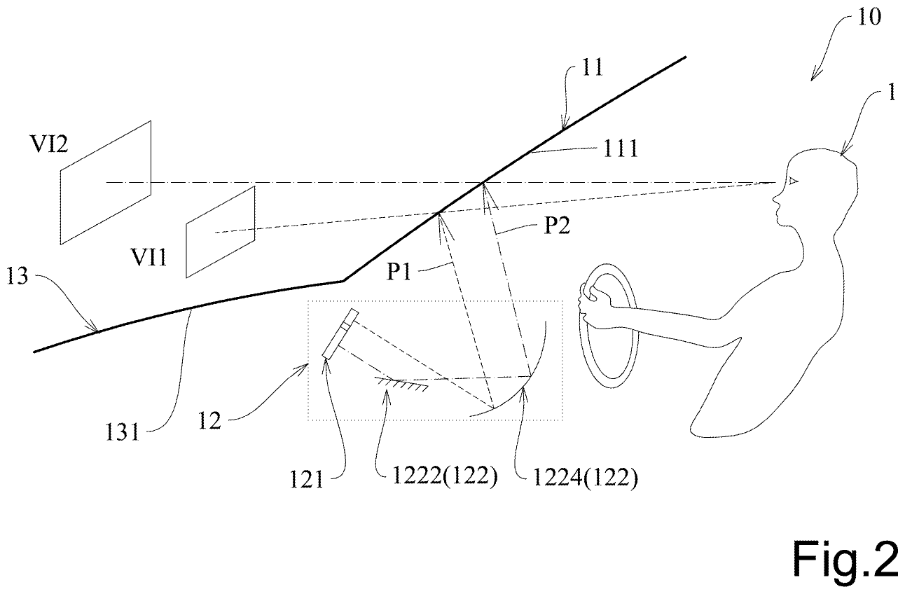

Refer to FIG. 2 a diagram schematically showing a display device and an automobile head-up display system using the same according to one embodiment of the present invention. The automobile head-up display system 10 of the present invention comprises a windshield 11 and a display device 12. The windshield 11 is joined with an automobile body 131 of an automobile 13 and has a surface 111. The display device 12 includes a picture generation unit (PGU) 121 and an optical imaging module 122. The PGU 121 is disposed inside the automobile body 131 and generates a first imaging light (not shown in the drawing) and a second imaging light (not shown in the drawing). The optical imaging module 122 is disposed at a light-output side of the PGU 121 and includes at least one plane mirror 1222 and at least one first curved mirror 1224, which reflect the first imaging light to the surface 111 of the windshield 11 through a first optical path P1 and reflect the second imaging light to the surface 111 of the windshield 11 through a second optical path P2 to respectively form a first virtual image VI1 and a second virtual image V12. The distance of the first optical path P1 is smaller than the distance of the second optical path P2. In one embodiment, the first imaging light is reflected by at least one first curved mirror 1224 to the surface 111 of the windshield 11; the second imaging light is reflected by at least one plane mirror 1222 and at least one curved mirror 1224 to the surface 111 of the windshield 11.

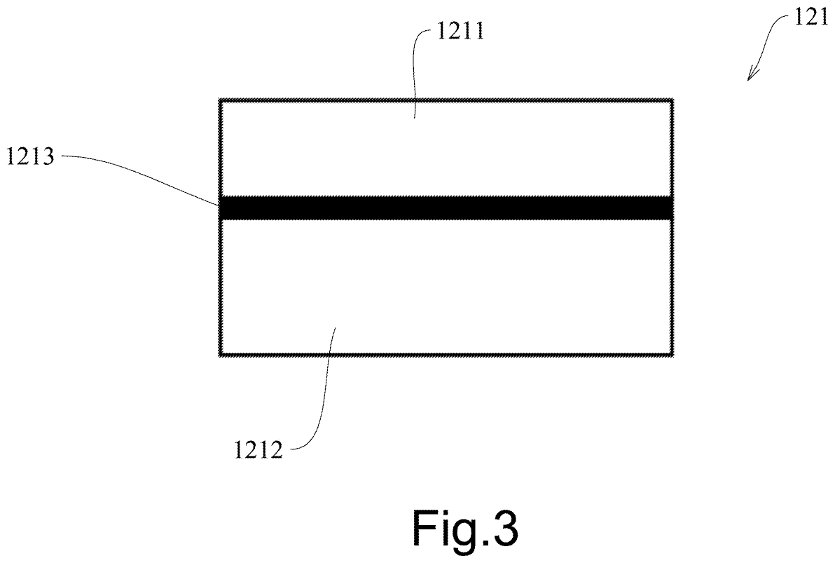

In one embodiment, the PGU 121 may be but is not limited to be a liquid crystal display (LCD) module, a digital light processing (DLP) module, a liquid crystal on silicon (LCOS) display module, or a laser display module. Refer to FIG. 3. In one embodiment, the PGU 121 includes an image panel, which further includes a first display region 1211 and a second display region 1212. The first display region 1211 and the second display region 1212 respectively generate the first imaging light and the second imaging light. In one embodiment, the PGU 121 is a single image panel. In one embodiment, the image panel has a small region (such as the region labeled by 1213) that does not participate in the imaging and is able to prevent from the interference of the optical paths. The unused region may be designed to match different mechanisms. In one embodiment, the image panel further has a third display region (not shown in the drawing) that generates a third imaging light. In the present invention, the image panel may include two or more display regions to generate two or more imaging lights. The present invention is characterized in dividing the area of the PGU into a plurality of display regions, which are independent in application but unseparated in structure, as shown in FIG. 3. FIG. 3 shows that the PGU 121 is divided into the first display region 1211 and the second display region 1212 to exemplify the division of the image panel and demonstrate the characteristics of the present invention. The first display region 1211 and the second display region 1212 are respectively corresponding to two different virtual images with different virtual image distances. In the present invention, the image panel division is not limited to be a rectangular division but may be an arbitrary geometric division. In the present invention, an unused region is allowed to exist for modifying the space configuration.

However, the unused region is not a necessity but an option in the present invention.

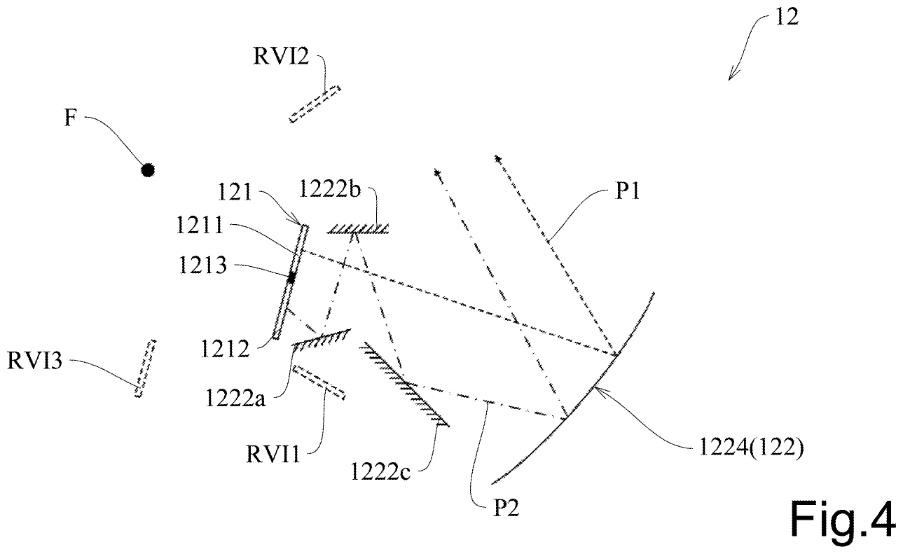

In order to distribute a plurality of display regions to different positions in space and acquire different object distances, the present invention uses plane mirrors, curved mirrors, lenses, etc. to image at least one display region to positions in space, which are different from the position of the PGU. The other display regions are kept at the original positions. Alternatively, the other display regions are imaged to the other positions in space by other optical image conversion systems (optical imaging modules), wherein the other positions are different from the position to which the abovementioned first image conversion system projects the corresponding display region. The embodiments shown in FIG. 3 and FIG. 4 are used for the further explanation below. FIG. 4 schematically shows another embodiment of the display device based on the embodiment shown in FIG. 2. In FIG. 3 and FIG. 4, the PGU 121 is divided into two display regions—the first display region 1211 and the second display region 1212—and an unused region 1213 therebetween. The light emitted by the first display region 1211 is directly projected to the first curved mirror 1224 and then reflected to the windshield 11 by the first curved mirror 1224 to form the first virtual image, such as the first virtual image VI1 shown in FIG. 2. The light emitted by the second display region 1212 is projected to the plane mirror 1222a and reflected by the plane mirror 1222a to form a first relay virtual image RVI1; the first relay virtual image RVI1 is reflected by the plane mirror 1222b to form a second relay virtual image RVI2; the second relay virtual image RVI2 is reflected by the plane mirror 1222c to form a third relay virtual image RVI3. Thus, the second display region 1212 is transferred by an optical image conversion system including the plane mirrors 1222a, 1222b, and 1222c to a position that is different from the original position of the PGU 121, i.e., the position of the third relay virtual image RVI3. Then, the third relay virtual image RVI3 is imaged by the first curved mirror 1224 and the windshield 11 to form a second virtual image, such as the second virtual image VI2 shown in FIG. 2. The first display region 1211 and the third relay virtual image RVI3 (i.e. the converted image of the second display region 1212), which are not influenced by the image conversion system, respectively have different distances to the first curved mirror 1224 and are within the range between the first curved mirror 1224 and its focus F thereof (if the system is designed appropriately). Thus, the first virtual image VI1 and the second virtual image VI2 respectively have different virtual image distances with respect to the driver 1, as shown in FIG. 2. In one embodiment, the virtual image distance of the second virtual image VI2, i.e. the distance between the driver 1 and the position where the second virtual image VI2 is formed, is greater than 2 meters. The present invention uses optical imaging systems to transfer at least one display region to other positions in space and make a plurality of display regions have different object distances with respect to the primary optical projection system (i.e. the first curved mirror 1224 in the embodiments).

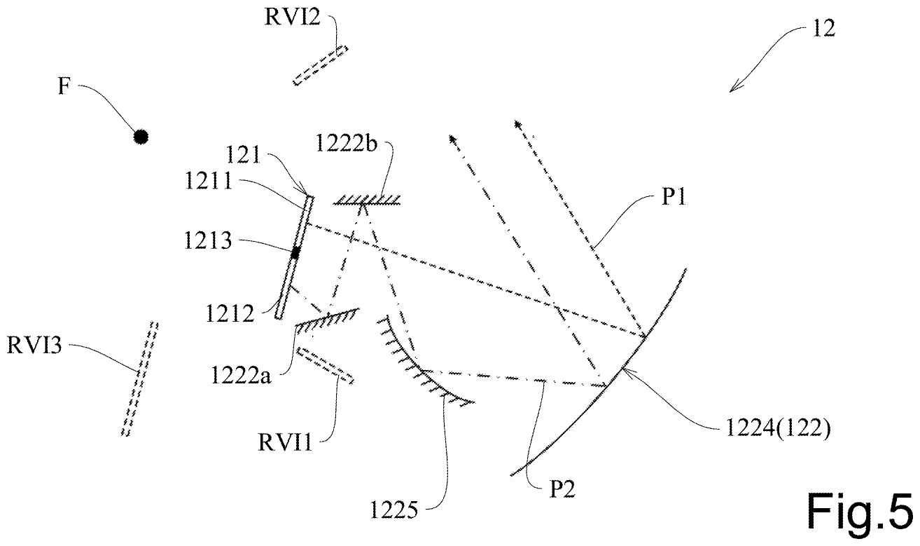

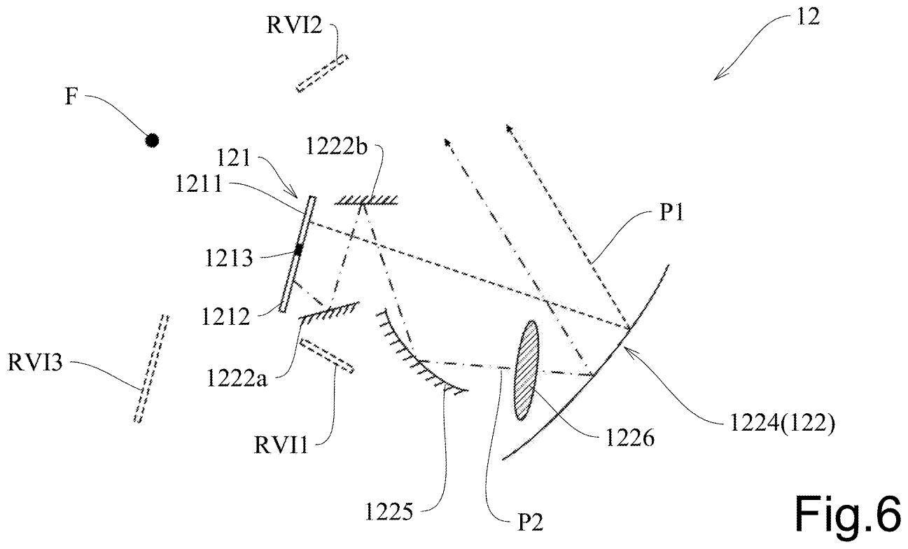

In the embodiment shown in FIG. 4, the optical imaging module includes three plane mirrors. Refer to FIG. 5. FIG. 5 schematically shows yet another embodiment of the display device based on the embodiment shown in FIG. 2. The embodiment shown in FIG. 5 is basically similar to the embodiment shown in FIG. 4 except that the optical imaging module 122 in FIG. 5 further includes a second curved mirror 1225. The second curved mirror 1225 is disposed in the second optical path P1 from the PGU 121 to the at least one first curved mirror 1224. In comparison with the embodiment shown in FIG. 4, the plane mirror 1222c of the optical imaging module 122 is replaced by the second curved mirror 1225 in the embodiment shown in FIG. 5. Because of the non-zero focal power introduced by the second curved mirror 1225, the size of the third relay virtual image RVI3 is larger than the size of the second display area 1212. In contrast, the size of the third relay virtual image RVI3 in FIG. 4 is identical to the size of the second display area 1212. Refer to FIG. 6. In one embodiment, the optical imaging module 122 includes plane mirrors 1222a and 1222b, a second curved mirror 1225, and a lens 1226. In the embodiment shown in FIG. 6, a lens 1226 is added to the structure of the embodiment shown in FIG. 5 to correct the magnification aberration of the second curved mirror 1225. The lens 1226 is disposed in the second optical path P2 from the PGU 121 to the second curved mirror 1225. The details thereof are based on ordinary knowledge of optics and will not be repeated herein. The persons skilled in the art can modify the design of the present invention to meet requirement without departing from the spirit of the present invention.

In the present invention, the optical image conversion system converts a single PGU into a plurality of objects respectively having different distances with respect to the primary optical projection system, whereby virtual images with different virtual image distances can be generated according to Gaussian optics. Further, the design of the primary optical projection system is optimized to acquire the image quality meeting the standards of HUD applications. In general, the standards of HUD applications include the modulation transfer function (MTF) value at the cut-off frequency that is determined by the pixel size of the PGU, the distortion rate, the astigmatism, the binocular disparity, etc. In addition, all the fields within the field of view (FOV) must meet these standards. The optimized optical design and the evaluation thereof is ordinary knowledge in the field and will not be repeated herein.

An example is provided herein to exemplify the automobile head-up display system using a single PGU and generating a plurality of virtual images of the present invention. In the example, the PGU 121 is a single 57 mm×34 mm liquid crystal display (LCD) panel whose diagonal is 2.6 inches in length; the panel is divided into two parts, as shown in FIG. 3; the first display region 1211 is sized 57 mm×14 mm, and the second display panel 1212 is sized 57 mm×16 mm; an unused region 1213 sized 57 mm×4 mm exists between the first display region 1211 and the second display region 1212; the structure of the display device is the same as that shown in FIG. 4; the first display region 1211 is not involved with the image conversion system; the image conversion system for the second display region includes three plane mirrors 1222a, 1222b and 1222c.

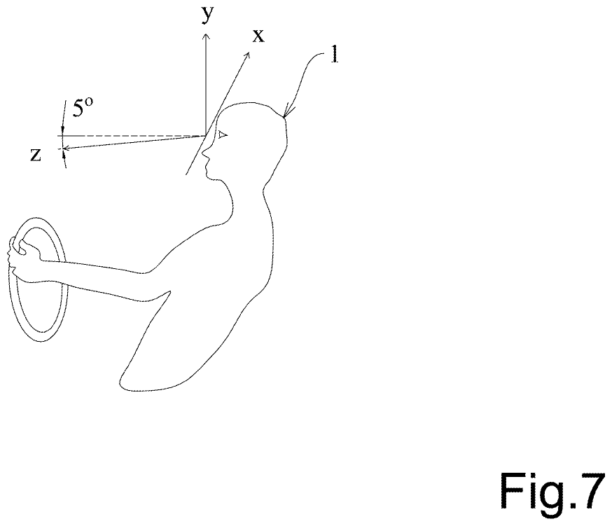

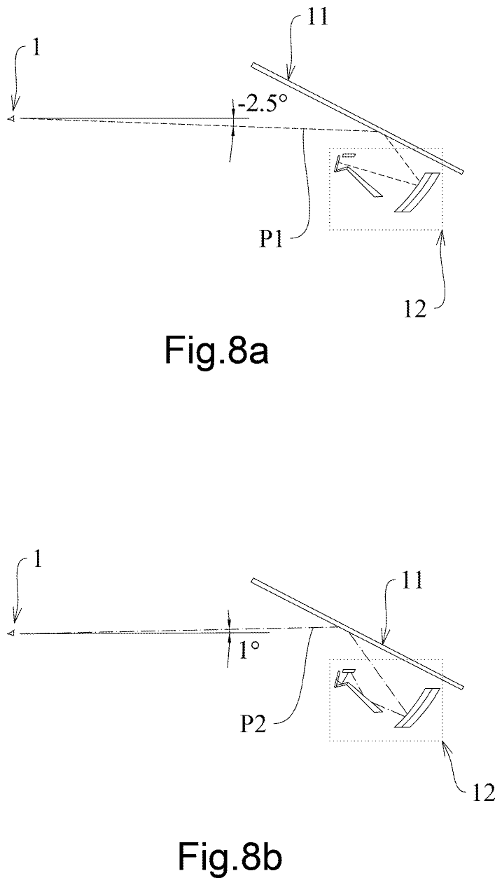

In this example, the curvature radius of the windshield 11 is 7500 mm in the direction vertical to the ground and 3000 mm in the direction horizontal to the ground. The coordinate system is established using the sight line of the driver 1, which has a look-down angle of 5 degrees with respect to the ground, as shown in FIG. 7. The field of view (FOV) of the first virtual image VI1 generated by the first display region 1211 ranges from −2.5° to 2.5° in the x direction and from −3.5° to −1.5° in the y direction; the distance of the first virtual image VI1 to the driver 1 is 2.5 m. The field of view (FOV) of the second virtual image VI2 generated by the second display region 1212 ranges from −5° to 5° in the x direction and from −0.5° to 2.5° in the y direction; the distance of the second virtual image VI2 to driver 1 is 9 m; the scope that both eyes can view the first virtual image VR1 and the second virtual image VR2, i.e. the eyebox, is 120 mm in the x direction and 60 mm in the y direction. The surface of the curved mirror 1224 of the optical imaging module 122 may be described by Equation (1), which is a biconic equation with six-order aspheric coefficients. The values of the parameters for a specified curved mirror 1224 are listed in Table. 1. FIG. 8a and FIG. 8b respectively show the optical paths, which include the eyes, of the central fields of the two display regions. It is seen in FIG. 8a and FIG. 8b that the two display regions are respectively processed into virtual images having different virtual image distances through an image conversion system and not through an image conversion system. Equation (1) that defines the curved mirrors 1224 of the optical imaging module 122 is expressed by:

$$z ( x , y ) = \frac{{c}_{x} {x}^{2} + {c}_{y} {y}^{2}}{1 + \sqrt{1 - ( 1 + {k}_{x} ) {c}_{x}^{2} {x}^{2} - ( 1 + {k}_{y} ) {c}_{y}^{2} {y}^{2}}} + {\sum }_{i = 1}^{{N}_{x}} {α}_{i} {x}^{i} + {\sum }_{i = 1}^{{N}_{y}} {β}_{i} {y}^{i} \qquad ( 1 )$$

TABLE 1

| cx | kx | α1 | α2 | α3 | α4 | α5 | α6 |
|---|---|---|---|---|---|---|---|
| 1/1.505E+06 | 2.066E+06 | 2.987E−03 | −0.013 | −5.394E−08 | −9.793E−09 | 4.995E−12 | 1.969E−15 |
| cy | ky | β1 | β2 | β3 | β4 | β5 | β6 |
| 1/36.482 | −0.966 | 0.625 | −3.392E−03 | 2.796E−005 | −1.067E−007 | 2.192E−010 | −1.800E−013 |

(Unit: mm)

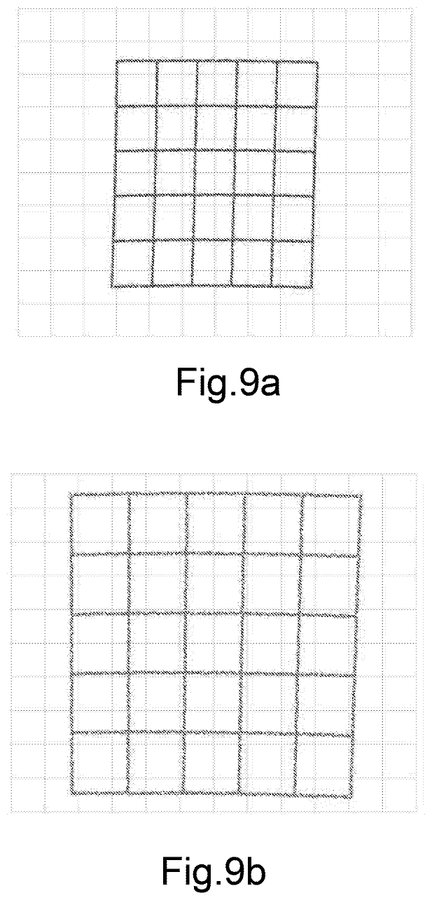

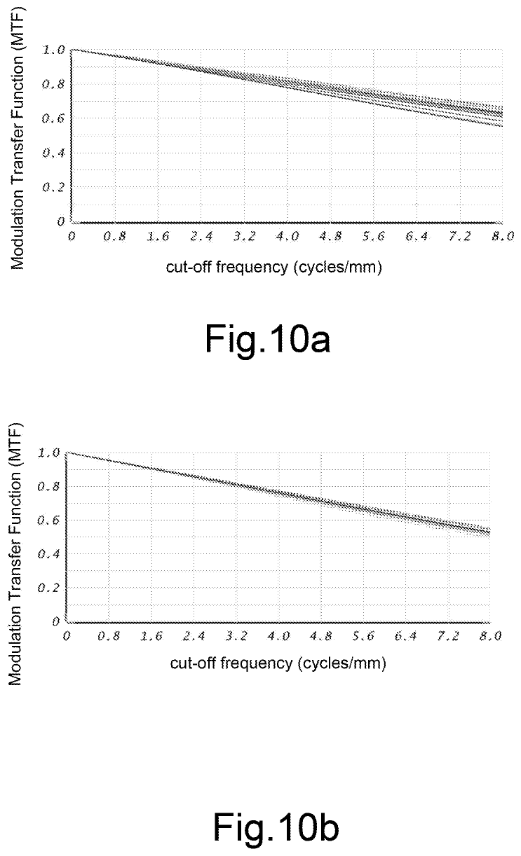

Refer to FIG. 9a, FIG. 9b, FIG. 10a, and FIG. 10b for the imaging quality of the present invention. In this example, the imaging simulations of the grid patterns of the two display regions and the MTF values at the cut-off frequency are used to verify the imaging quality. It is observed in FIG. 9a and FIG. 9b: the distortion rates of the virtual images corresponding to the two display regions are very low and less than 5%. It is observed in FIG. 10a and FIG. 10b: the MTF values at the cut-off frequency (8 cycles/mm), which is determined by the sizes of the LCD pixels of the first display region 1211 and the second display regions 1212, are higher than 0.5. It means that the present invention is a diffraction-limited system. According to the ordinary knowledge of the optics of imaging visibility, the pictures imaged by the system are clear.

According to the above discussion, the present invention proposes a display device and an automobile head-up display system, wherein the PGU of the display device provides at least two image sources to function as the display regions, which are independent in application but unseparated in structure. The optical imaging module of the display device includes at least one plane mirror and at least one curved mirror, which may be flexibly configured according to different PGUs for different image conversions so as to generate at least two clear virtual images.

In conclusion, the display device and automobile head-up display system of the present invention uses a single PGU to generate at least two virtual images with different virtual image distances, whereby to provide the driver with a plurality of pieces of driving information and decrease the cost of the automobile head-up display system in components and fabrication.

What is claimed is:

1. An automobile head-up display system comprising:
a windshield joined with an automobile body of an automobile and having a surface able to reflect light; and
a display device including
a picture generation unit disposed inside the automobile body and generating a first imaging light and a second imaging light; and
an optical imaging module disposed at a light-output side of the picture generation unit and including at least one plane mirror and at least one first curved mirror, which reflect the first imaging light to the surface of the windshield through a first optical path and reflect the second imaging light to the surface of the windshield through a second optical path to respectively form a first virtual image and a second virtual image, wherein the distance of the first optical path is smaller than a distance of the second optical path.

2. The automobile head-up display system according to claim 1, wherein the picture generation unit is selected from a group including a liquid crystal display module, a digital light processing module, a liquid crystal on silicon (LCOS) display module, and a laser display module.

3. The automobile head-up display system according to claim 1, wherein the picture generation unit includes an image panel, which further incudes a first display region and a second display region; the first display region and the second display region respectively generate the first imaging light and the second imaging light.

4. The automobile head-up display system according to claim 1, wherein the first imaging light is reflected to the windshield by the at least one first curved mirror, and the second imaging light is reflected to the windshield by the at least one plane mirror and the at least one curved mirror.

5. The automobile head-up display system according to claim 1, wherein the optical imaging module further includes a second curved mirror; alternatively, the optical imaging module further includes a second curved mirror and a lens, which are disposed in the second optical path between the picture generation unit and the at least one first curved mirror.

6. A display device comprising
a picture generation unit disposed inside an automobile body of an automobile and generating a first imaging light and a second imaging light; and
an optical imaging module disposed at a light-output side of the picture generation unit and including at least one plane mirror and at least one first curved mirror, which reflect the first imaging light to a surface of a windshield through a first optical path and reflect the second imaging light to the surface of the windshield through a second optical path to respectively form a first virtual image and a second virtual image, wherein the distance of the first optical path is smaller than the distance of the second optical path.

7. The display device according to claim 6, wherein the picture generation unit is selected from a group including a liquid crystal display module, a digital light processing module, a liquid crystal on silicon (LCOS) display module, and a laser display module.

8. The display device according to claim 6, wherein the picture generation unit includes an image panel, which further includes a first display region and a second display region; the first display region and the second display region respectively generate the first imaging light and the second imaging light.

9. The display device according to claim 6, wherein the first imaging light is reflected to the windshield by the at least one first curved mirror, and the second imaging light is reflected to the windshield by the at least one plane mirror and the at least one curved mirror.

10. The display device according to claim 6, wherein the optical imaging module further includes a second curved mirror; alternatively, the optical imaging module further includes a second curved mirror and a lens, which are disposed in the second optical path between the picture generation unit and the at least one first curved mirror.
